(19) United States
(12) Patent Application Publication
(10) Pub. No.: US 2005/0022808 A1
(43) Pub. Date: Feb. 3, 2005

(54) Rodent euthanasia machine

(76) Inventor: Joseph Raymond Caplette, Mesa, AZ (US)

Correspondence Address: JOSEPH R CAPLETTE, 757 W NOPAL CIR, MESA, AZ, 85210, US

(21) Appl. No.: 10/772,669

(22) Filed: Feb. 5, 2004

Related U.S. Application Data
(60) Provisional application No. 60/444,872, filed on Feb. 5, 2003.

(51) Int. Cl. A62B 7/00

(52) U.S. Cl. 128/200.24

(57) ABSTRACT

Most research papers discussing rodent euthanasia with the use of Carbon Dioxide speak of the high level of distress that can be prevalent (3,4,5,6). The narcotic effects of CO2 are well known but equipment to properly utilize these effects are presently not available (6). The basis of this equipment is to provide narcosis in as gentle a manner possible allowing distress during euthanasia to be absolutely minimized. This is accomplished by providing well controlled flow stages properly utilizing the low level odorless narcotic properties of CO2 and achieving the correct levels at the correct time intervals.

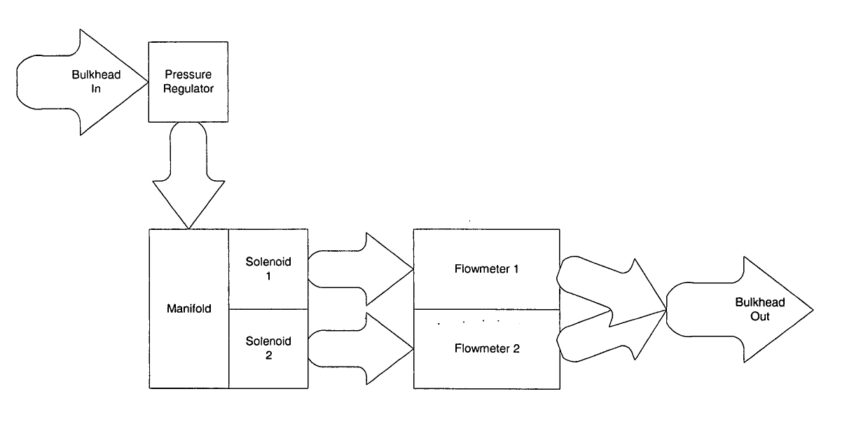

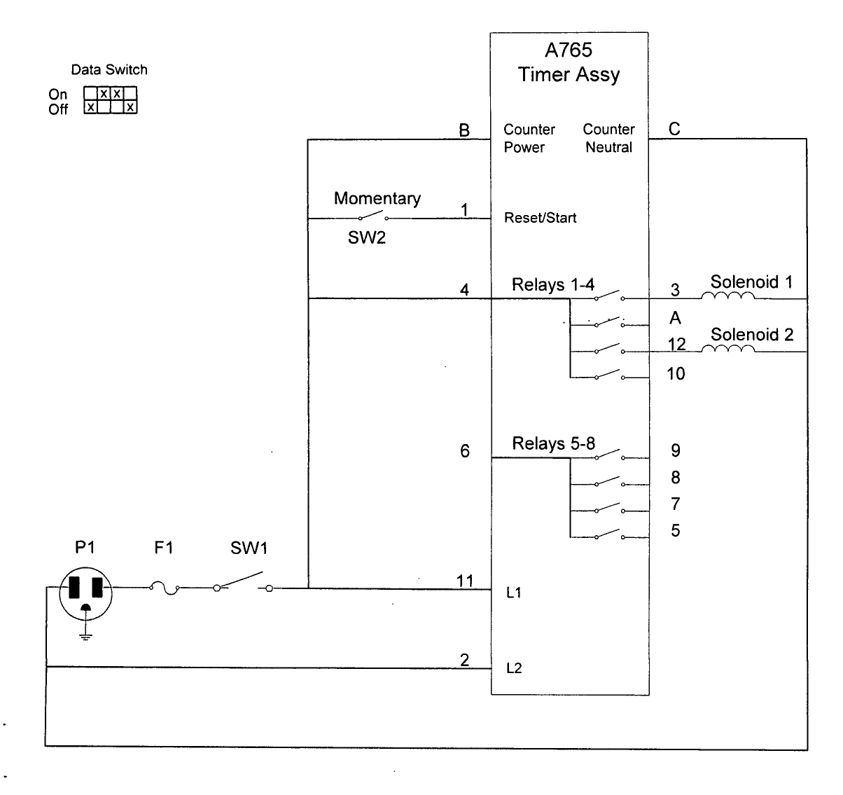

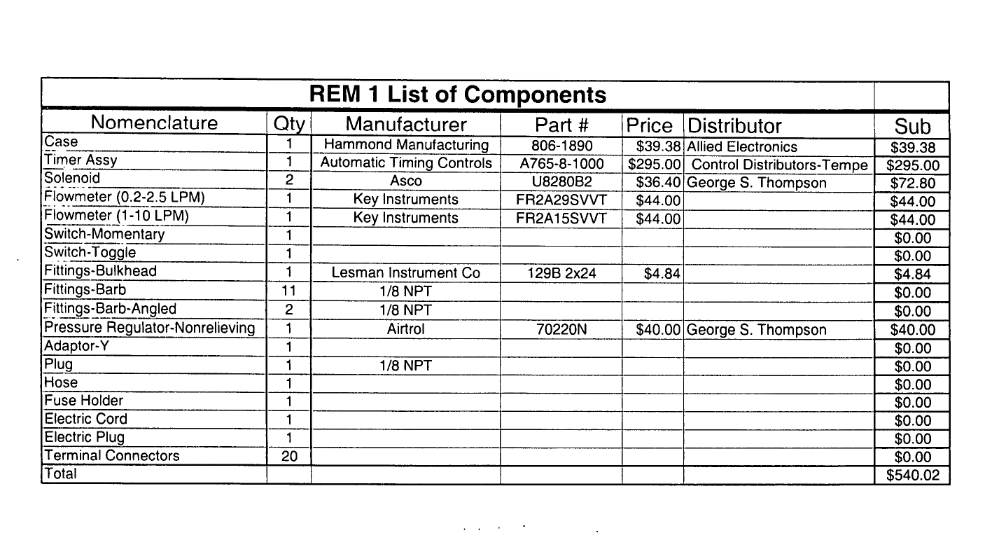

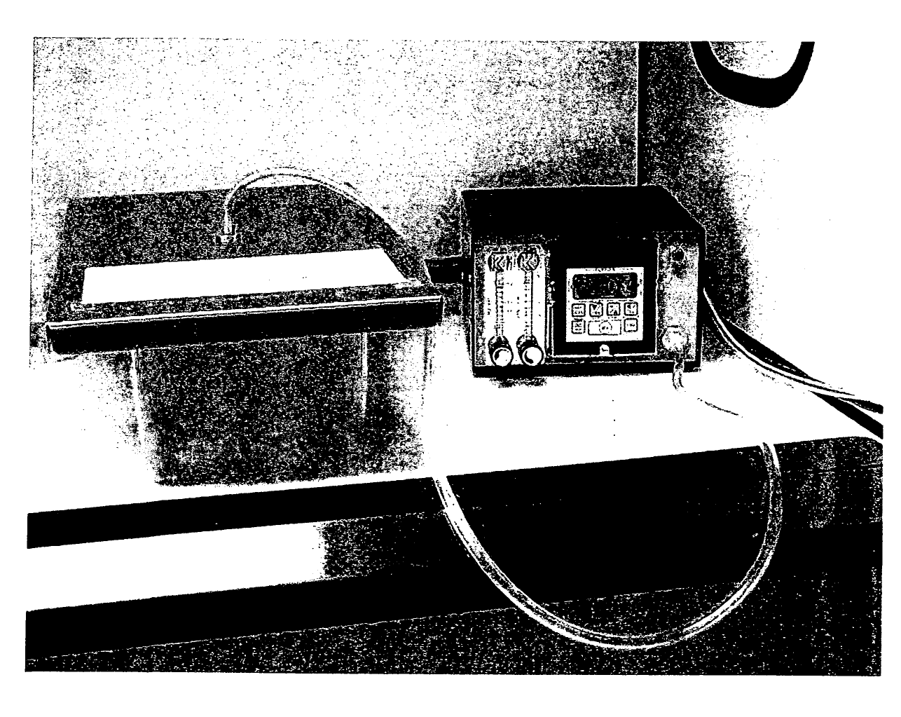

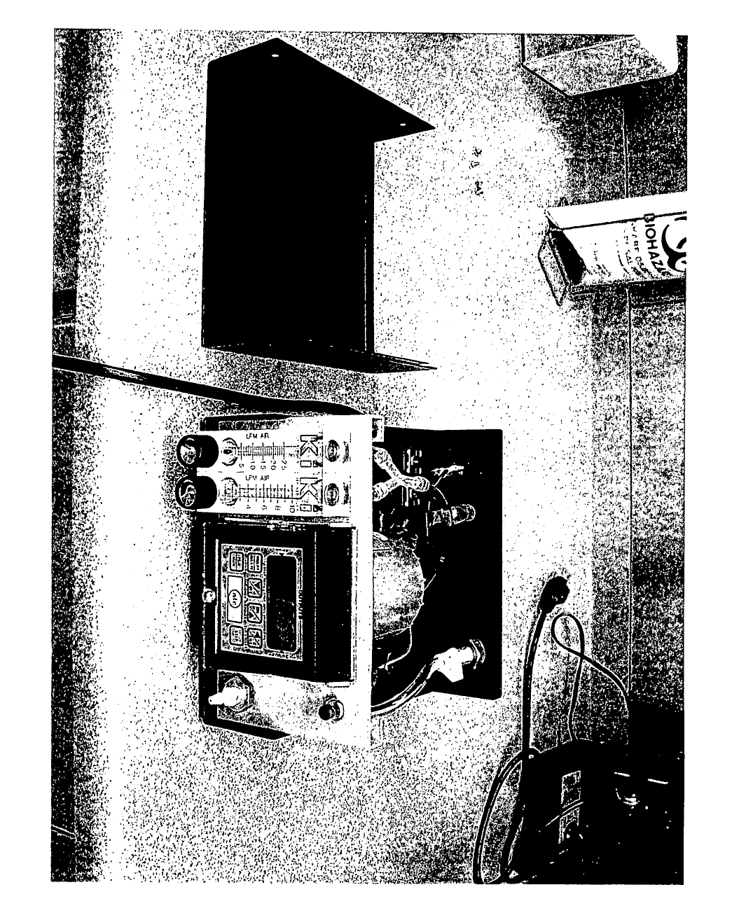

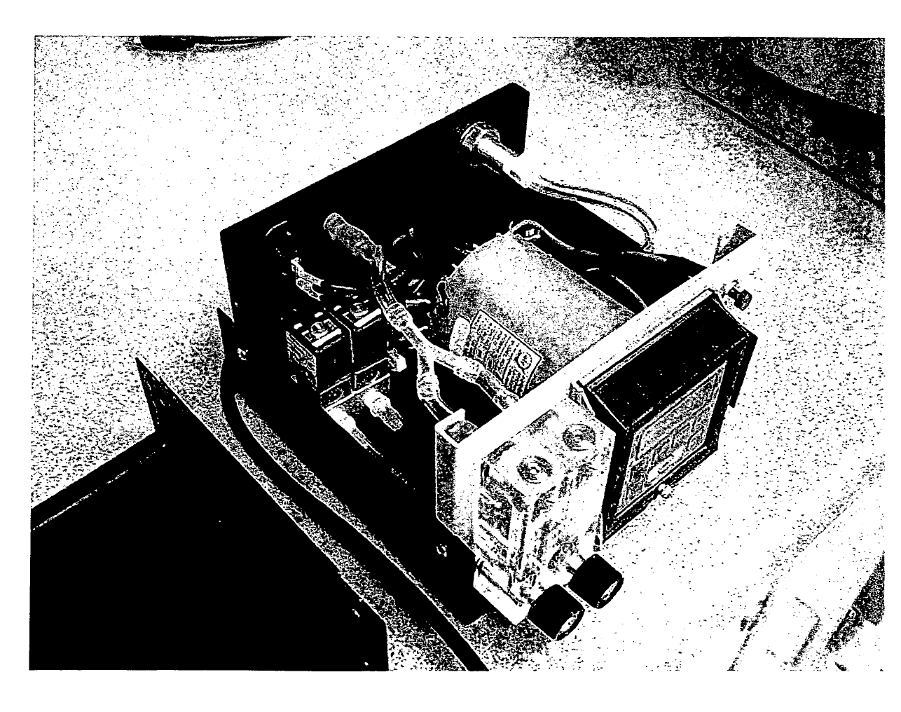

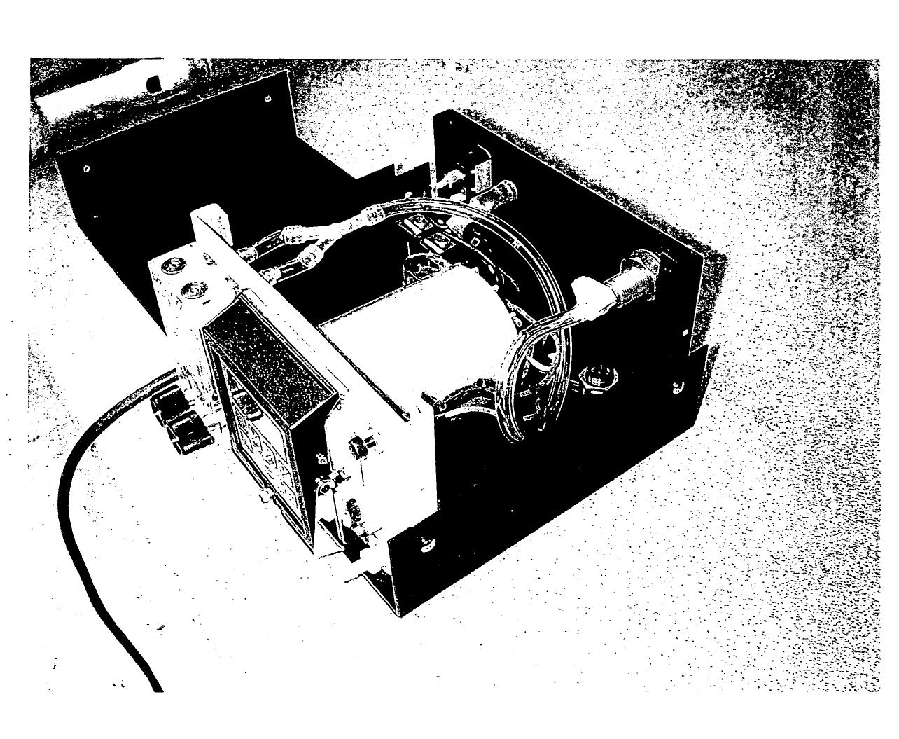

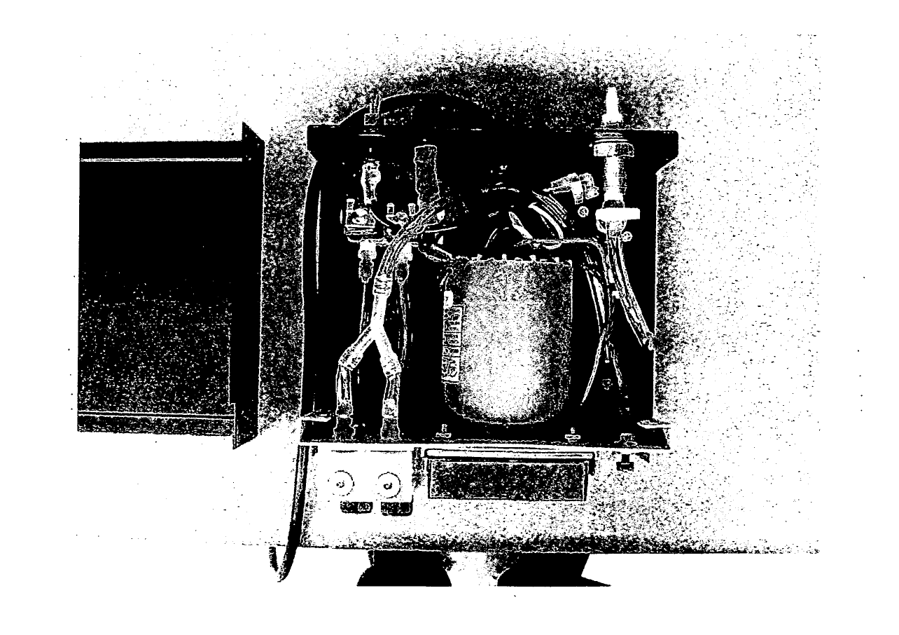

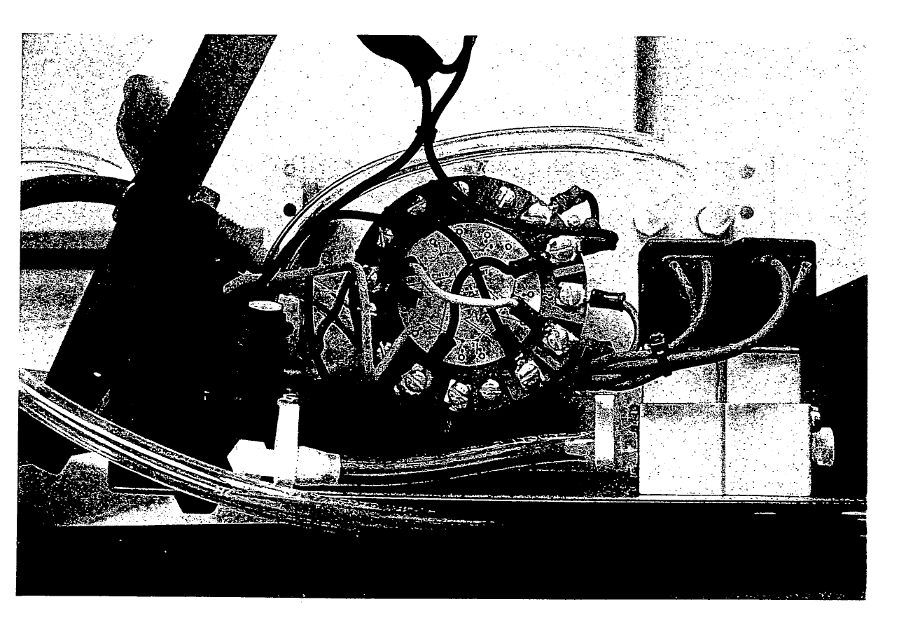

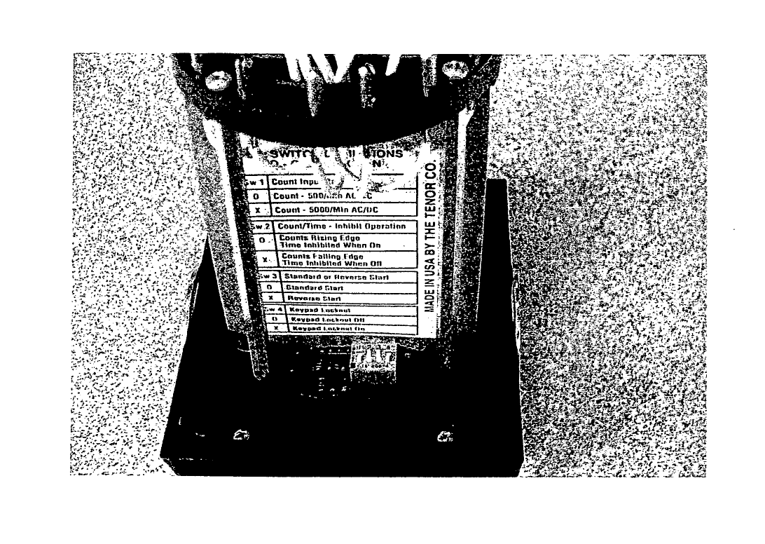

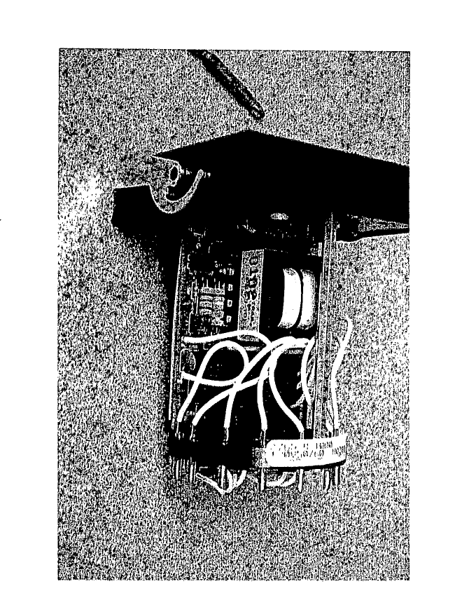

### BACKGROUND INFORMATION

The subject of Euthanasia in the Biomedical Research industry is not an easy one. Debates occur as to which are the preferred methods and for what reasons. Standards have been set by the American Veterinary Medical Association (1) and the Canadian Council on Animal Care (2) encompassing numerous points of consideration. The points are valid and for the right reasons. Although most goals are met by the Research industry, a few are difficult to achieve. Such is the case with the carbon dioxide euthanasia of small animals and rodents.

Most research papers discussing this topic speak of the high level of distress that is prevalent with CO2 euthanasia (3,4,5,6). Tests were conducted on humans to better understand exactly what these levels actually are (4). Although disagreements exist (6), euthanasia involving CO2 is the preferred method for small animal and rodents (6). The gas is colorless and considered scentless at low concentrations (6). It also has a quick uptake (6). The narcotic effects of CO2 are well known but equipment to properly utilize these effects are presently not available (6). CO2 euthanasia in its present form is basically tolerated (6).

Presently, all other processes involving strictly CO2 are at a single flow rate or a single concentration (3,4,5,6). No articles found discuss a dosing technique to maximize narcosis. Although numerous papers discuss mixing oxygen levels to reduce pain and distress, no procedures presently utilizing CO2 satisfy the conditions set forth by the AVMA or CCAC. This procedure appears to be the first to satisfy all 12 definitions specified in the General Considerations paragraph of the 2000 Report of the AVMA Panel on Euthanasia page 673.

This machine is the first of its kind that will allow for the narcotic effect of CO2 to be properly utilized during the euthanasia process. It will insure narcosis before suffocation guaranteeing a tightly controlled process with the lowest amount of distress possible. It's objective is to provide the most humane treatment of animals possible during the carbon dioxide euthanasia process.

### APPLICTION FOR NONPROVISIONAL PATENT

This is an application for a nonprovisional patent. The machine mentioned here will be known as a Rodent Euthanasia Machine. The model will be known as the R.E.M. 1.

The principle of operation is simple in nature. Carbon Dioxide enters the machine from a research or medical grade CO2 source in the pressure range of 20 PSI to 150 PSI. The CO2 is then regulated internally at approximately 15 PSI and delivered to a manifold with 2 solenoids. Each solenoid has its own flowmeter attached and the unit is constructed to have two regulated flow channels. The two channels are recombined to form one output connected to an output bulkhead connection. The solenoid time durations are controlled by a step timer. The output from the bulkhead fitting is then delivered to a nonsealed lid above the animal cage being utilized.

The program operation is also simple in nature. It contains 4 steps:
Step 1 titrates carbon dioxide for a desired narcotic setpoint.
Step 2 is the necessary wait time to insure narcosis properly sets in.
Step 3 will then titrate carbon dioxide with the second flowmeter to cause a CO2 level of almost 100 percent.
Step 4 is then the wait time needed to insure nonreversible euthanasia.

As one can easily see flowmeter 1 is controlled by program step 1 and flowmeter 2 is controlled by program step 3. Setting flowmeter 1 at 2.0 LPM for 30 seconds achieves a 20% CO2 level internal to the Thoren small mouse cage. Setting step 2 for a wait time of 15 seconds has yielded results with mice that appear to have no visible distress. This instrument is made to be versatile because many different size cages are used in the Research industry. Both time durations and flows can be preset by the operator to optimize the best conditions for their environment.

To start a sequence, a single momentary switch is depressed. This will both reset the device and start the program.

### CONCLUSION

Different animals will require different settings. It is possible the first stage of 20% CO2 will be proper for most rodents or small animals. However, the second stage will need to be altered accordingly. For instance, mice have a heart rate of approximately 800 BPM and a respiratory rate of approximately 160 BPM. That's a breath rate of once per second. Rats have a heart rate of approximately 300 BPM and a breath rate of approximately 60 BPM. Induction times of different animals have been plotted so large amounts of good data is available. Still more work will need to be done to optimize settings for individual species.

The work conducted with this machine to date has all been done with mice. Using a Thoren small mouse cage, the first stage is set to 2.0 LPM for 35 seconds. The second stage is set to 20 seconds and is possibly longer than necessary. The third stage is set to 8 LPM for 60 seconds estimating a 100% CO2 level. The fourth stage is set for 2 minutes.

The amount of pain or suffering witnessed during the mouse euthanasia process has been none. The results appear to be far more humane than any other CO2 euthanasia process known. Normally, distress during CO2 euthanasia is readily visible. No distress is visible utilizing this machine and titration dosing technique.

### REFERENCES

References

1. American Veterinary Medical Association, 2000. Report of the AVMA panel on euthanasia. J. Am. Vet. Med. Assoc. 218:669-696.

2. Olfert, E. D., B. M. Cross, and A. A. McWilliams eds. 1993. Guide to the care and use of experimental animals, vol. 1, 2^{nd} ed. Canadian Council on Animal Care, Ottawa.

3. Leach, M. C., V. A. Bowell, T. F. Allan, and D. B. Morton. 2002. Aversion to Gaseous Euthanasia Agents in Rats and Mice. Comparative Medicine. 52:249-257

4. Danneman, P. J., S. Stein, and S. O. Walshaw. 1997. Humane and Practical Implications of Using Carbon Dioxide Mixed with Oxygen for Anesthesia or Euthanasia of Rats. Lab. Anim. Sci. 47:376-385

5. Pecaut, M. J., A. L. Smith, T. A. Jones, and D. S. Gridley. 2000. Modification of Immunologic and Hematologic Variables by Method of CO2 Euthanasia. Comp. Med. 50:595-602

6. Kohler, I., R. Meier, A. Busato, G. Neiger-Aeschbacher, and U. Schatzmann. 1999. Is carbon dioxide (CO2) a useful short acting anaesthetic for small laboratory animals? Lab Anims 33:155-161

1. A Euthanasia machine comprising:
a. Flowmeters for regulated delivery of gaseous Carbon Dioxide,
b. Solenoids for gating gas flows,
c. Electronic controller for sequencing gas delivery and time durations,
Whereby delivery of Carbon Dioxide gas to a known volume chamber can be controlled achieving preset levels for preset time durations,
Whereby the narcotic effect of Carbon Dioxide gas can be maximized while distress to rodents and small animals can be minimized.
